(19) United States
(12) Patent Application Publication
(10) Pub. No.: US 2014/0062683 A1
(43) Pub. Date: Mar. 6, 2014

(54) BODY SENSING COMPUTER KEYBOARD

(71) Applicant: You-Chi LIU, Taipei City (TW)

(72) Inventor: You-Chi LIU, Taipei City (TW)

(73) Assignees: NZXT CORPORATION, Monte, CA (US); You-Chi LIU, Taipei City (TW)

(21) Appl. No.: 13/604,503

(22) Filed: Sep. 5, 2012

(51) Int. Cl. G08B 6/00

(52) U.S. Cl. 340/407.2

(57) ABSTRACT

A body sensing computer keyboard includes a trigger module defining a vibratable part and a non-vibratable part, a plurality of key buttons respectively clickable to trigger the trigger module in generating a respective signal, a displacement unit set between the trigger module and the key buttons, and a vibrator provided at the bottom side of the vibratable part of the trigger module and electrically connected to a vibration driving circuit of the trigger module for vibrating the vibratable part when one key button is clicked to trigger the trigger module.

### BACKGROUND OF THE INVENTION

1. Field of the Invention

The present invention relates to computer keyboard technology and more particularly, to a body sensing computer keyboard, which generates vibrations upon clicking a key button, enabling the user to feel a true shock during the playing of a computer game.

2. Description of the Related Art

With the advent of computer and fast development and wide spread of Internet technology, you can see computer in different places in our life. A computer is so smart and can do many things. People may use a computer to help office work or home study, to do many other works such as word processing, statistical computing and graphics, image processing, audio and video playback, query information, shopping, chat and other functions and processing. Because the computer brings convenience to people, it has become an integral part of our lives.

In addition to the host and the screen, the keyboard and the mouse are requisite parts of a computer system. By means of manipulating or pressing the keyboard and the mouse, a user can control computer operations. After years of research and development, keyboard structures have been very sound, but in actual use, there are still many shortcomings to be improved. For example, when a key button is clicked, the linked structure will be moved up and down to compress an elastomer and to further trigger a circuit board, causing the circuit board to produce a trigger signal. However, during the stroke of the clicked key button, the user may be unable to know accurate generation of the trigger signal by means of hand feeling. Therefore, conventional computer keyboards commonly provide a stop structure to limit the down stroke of each key button and to give a reaction force upon completion of the down stroke of each clicked key button. In typing, typing speed affects processing speed. Because there is a limit on human response and action, conventional computer keyboards limit user's typing speed, resulting in more time on processing.

Further, in addition to work and study purposes, computer can also be used to play video games. Playing a computer game is to focus on sound and vision. However, increasing the effect of feeling in the game can make people more likely to play the game. Home video game consoles with a vibration joystick have been created many years ago. By an action in the game to allow the software to generate a corresponding vibration signal and to transmit the vibration signal to the vibration joystick, the vibration joystick creates a vibration effect. However, there is no any commercial computer keyboard can create vibration.

### SUMMARY OF THE INVENTION

The present invention has been accomplished under the circumstances in view. It is therefore the main object of the present invention to provide a body sensing computer keyboard, which comprises a trigger module, a plurality of key buttons, a displacement unit, and a vibrator. The trigger module comprises a circuit board carrying a microprocessor and a vibration driving circuit, an elastomer layer disposed at the top side of the circuit board, and a bottom support board attached to the bottom side of the circuit board. The circuit board, the elastomer layer and the bottom support board each comprise a non-vibratable part and a vibratable part. The vibrator is provided at the bottom side of the vibratable part of the bottom support board of the trigger module and can be driven by the vibration driving circuit to vibrate the vibratable parts of the trigger module and the corresponding key buttons subject to the control of the microprocessor upon triggering of the circuit board by one key button, and thus, the user can release the finger from each pressed key button immediately upon vibration of the vibrator without moving the key button to the lower limit position, shortening the stroke of the key button.

Further, when one key switch is pressed to trigger the circuit board, only a local part of the body sensing computer keyboard will be vibrated during vibration of the vibrator, enabling the user to feel a true shock during the playing of a computer game. When performing word processing, connecting the body sensing computer keyboard to the internet, or operating the body sensing computer keyboard to key in data, the non-vibratable parts of the circuit board, elastomer layer and bottom support board of the trigger module are free from the effects of vibration of the vibratable parts.

Further, buffer cushions are connected between the non-vibratable parts of the circuit board, elastomer layer and bottom support board of the trigger module and the respective vibratable parts. The buffer cushions not only connect the vibratable parts of the circuit board, elastomer layer and bottom support board of the trigger module and the respective non-vibratable parts to avoid the necessity of modifying the mounting structures of the holder shell and the base member but also can absorb vibrating waves during operation of the vibrator to vibrate the vibratable parts of the circuit board, elastomer layer and bottom support board of the trigger module.

### BRIEF DESCRIPTION OF THE DRAWINGS

FIG. 1 is an exploded view of a body sensing computer keyboard in accordance with a first embodiment of the present invention.

FIG. 2 corresponds to FIG. 1 when viewed from another angle.

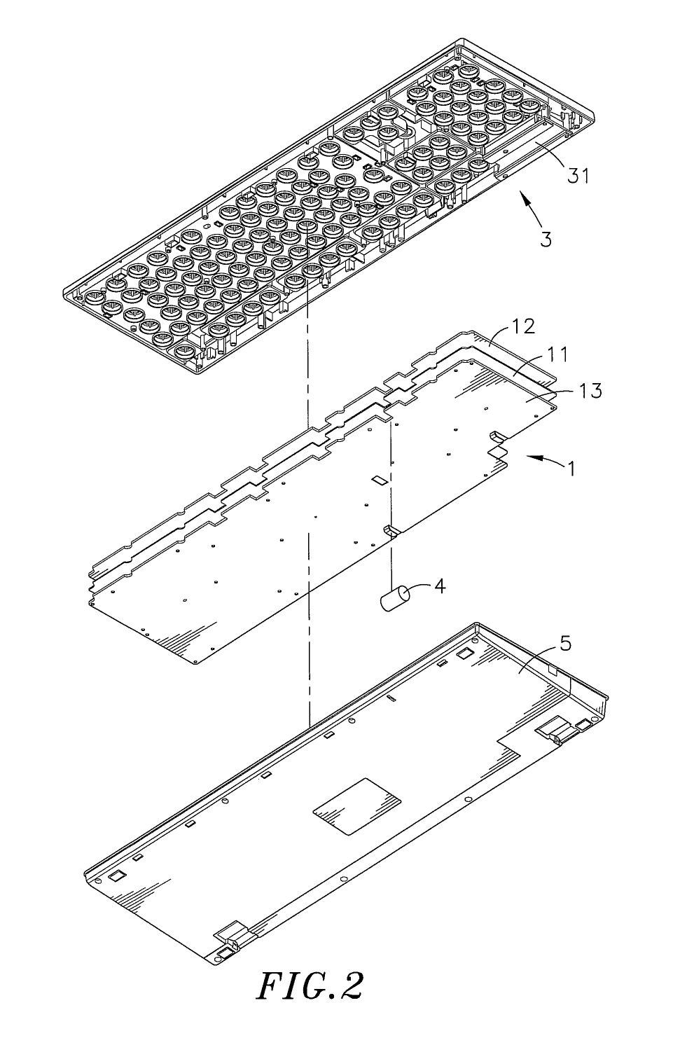

FIG. 3 is a circuit block diagram of the body sensing computer keyboard in accordance with the first embodiment of the present invention.

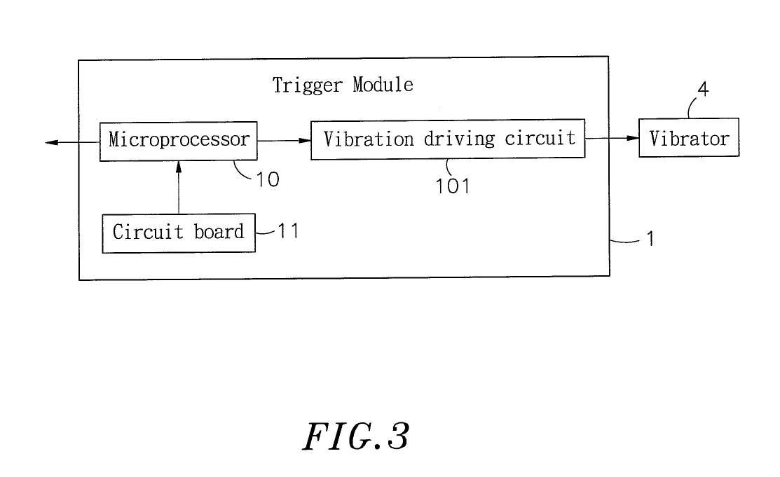

FIG. 4 is an exploded sectional side view of the body sensing computer keyboard in accordance with the first embodiment of the present invention.

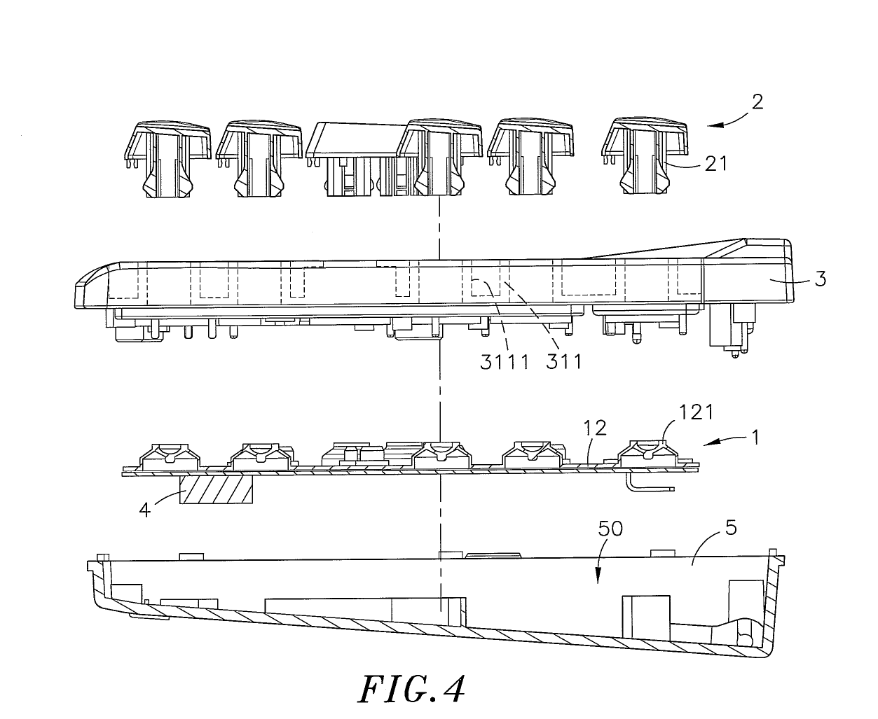

FIG. 5 is an exploded view of a body sensing computer keyboard in accordance with a second embodiment of the present invention.

FIG. 6 is an exploded view of a body sensing computer keyboard in accordance with a third embodiment of the present invention.

FIG. 7 is an exploded view of a body sensing computer keyboard in accordance with a fourth embodiment of the present invention.

### DETAILED DESCRIPTION OF THE PREFERRED EMBODIMENT

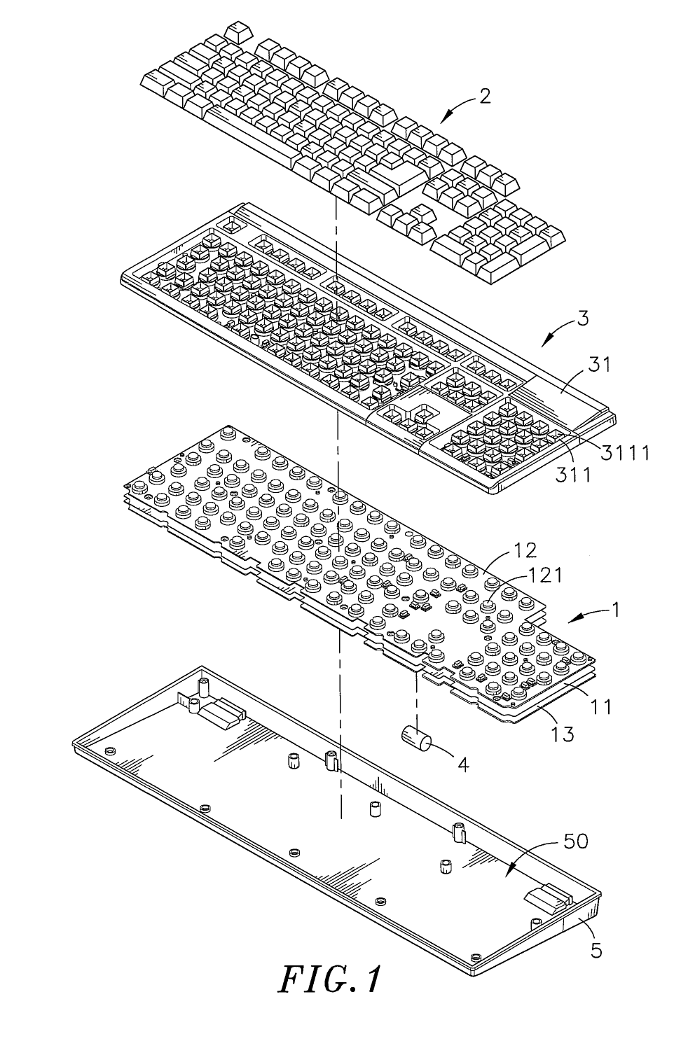

Referring to FIGS. 1˜4, an exploded top elevational view, an exploded bottom elevational view, a circuit block diagram and a sectional side view of a body sensing computer keyboard in accordance with the present invention is shown. The body sensing computer keyboard comprises a trigger module 1, a plurality of key buttons 2, a displacement unit 3, at least one vibrator 4, and a base member 5.

The trigger module 1 comprises a circuit board 11 carrying a microprocessor 10 and a vibration driving circuit 101, an elastomer layer 12 disposed at the top side of the circuit board 11, and a bottom support board 13 attached to the bottom side of the circuit board 11 to give support. The elastomer layer 12 comprises a plurality of rubber cones 121 respectively elastically compressible to trigger the circuit board 11 in generating a respective signal.

The key buttons 2 are respectively mounted at the top side of the trigger module 1 corresponding to the respective rubber cones 121, each comprising a downwardly extending plunger 21.

The displacement unit 3 is set between the trigger module 1 and the key buttons 2, comprising a holder shell 31, a plurality of raised guide blocks 311 formed integral with the holder shell 31 and arranged at locations corresponding to the key buttons 2, and a vertical sliding way 3111 cut through opposing top and bottom sides of each of the raised guide blocks 311 to guide vertical movement of the plunger 21 of each respective key button 2.

The vibrator 4 is provided at the bottom side of the bottom support board 13 of the trigger module 1, and electrically connected to the vibration driving circuit 101.

The base member 5 is provided at the bottom side of the bottom support board 13 of the trigger module 1 and the vibrator 4 and assembled with the holder shell 31 of the displacement unit 3, defining with the holder shell 31 an accommodation chamber 50 that accommodates the trigger module 1 and the vibrator 4.

The top side of the circuit board 11, the elastomer layer 12, the bottom support board 13, the key buttons 2, the holder shell 31, the raised guide blocks 311 and the base member 5 are of the known art and not within the scope of the claims of the present invention, and no further detailed description in this regard will be necessary.

Referring to FIGS. 1˜4 again, when the user presses (or clicks) one key button 2 during the use of the body sensing computer keyboard, the plunger 21 of the respective key button 2 will be lowered along the vertical sliding way 3111 in the respective raised guide blocks 311 of the displacement unit 3 to stop against the respective rubber cone 121 of the elastomer layer 12, thereby elastically deforming the respective rubber cone 121 to trigger the circuit board 11 of the trigger module 1 in providing a respective trigger signal to the microprocessor 10. Thus, the microprocessor 10 causes the vibration driving circuit 101 to drive the vibrator 4 to vibrate vertically or horizontally. Because the vibrator 4 is provided at the bottom side of the bottom support board 13, vibration of the vibrator 4 can cause the circuit board 11, the elastomer layer 12 and the respective key button 2 to vibrate. After the user released the finger from the pressed (or clicked) key button 2, the respective rubber cone 121 of the elastomer layer 12 immediately returns to its former shape to return the respective key button 2 to its former position.

Thus, when the user presses (or clicks) one key button 2 to force the respective rubber cone 121 to trigger the circuit board 11 of the trigger module 1, the user can release the finger from the pressed key button 2 immediately upon vibration of the vibrator 4 without moving the key button 2 to the lower limit position in the respective raised guide block 311 where the respective raised guide block 311 can give a reaction force to the pressed (or clicked) key button 2, thereby shortening the stroke of the key button. Further, because the vibrator 4 can vibrate only when a trigger signal is accurately produced, the invention eliminates the problem of being necessary to re-press (or re-click) the key button due to an early release of the key button before generation of a trigger signal.

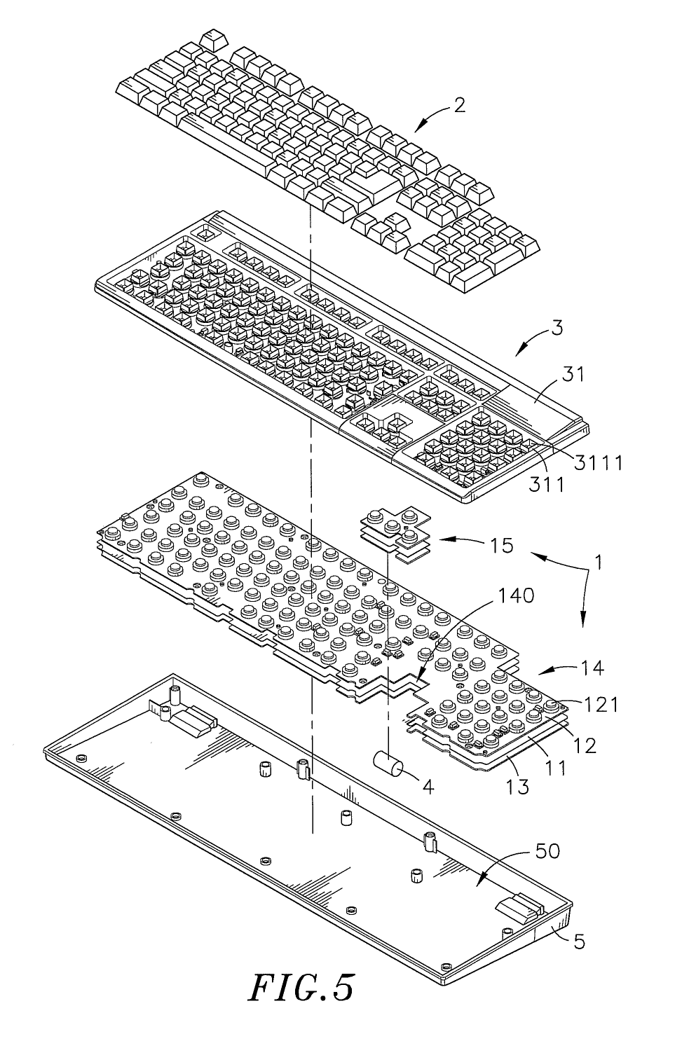

FIG. 5 illustrates a body sensing computer keyboard in accordance with a second embodiment of the present invention. This second embodiment is substantially similar to the aforesaid first embodiment with the exception of the configuration of the trigger module 1. According to this second embodiment, the circuit board 11, elastomer layer 12 and bottom support board 13 of the trigger module 1 each defines a non-vibratable part 14 and a vibratable part 15. The non-vibratable parts 14 of the circuit board 11, elastomer layer 12 and bottom support board 13 of the trigger module 1 provide a respective opening 140 to accommodate the vibratable parts 15 of the circuit board 11, elastomer layer 12 and bottom support board 13 of the trigger module 1 respectively. The vibrator 4 is provided at the bottom side of the vibratable part 15 of the bottom support board 13. Thus, when the vibrator 4 is vibrating, the vibratable parts 15 of the circuit board 11, elastomer layer 12 and bottom support board 13 of the trigger module 1 and the respective key buttons 2 above the vibratable parts 15 are being vibrated, and the non-vibratable parts 14 of the circuit board 11, elastomer layer 12 and bottom support board 13 of the trigger module 1 and other key buttons 2 remain immovable. Thus, when designing a body sensing computer keyboard for playing computer games, the location of the vibratable parts 15 can be selected subject to the location of one or a number of key buttons 2 that are to be frequently clicked during a computer game. This design of body sensing computer keyboard enables the user to feel a true shock when playing a computer game, making the computer game much more interesting and entertaining to play. Further, when the user clicks any other key button 2 corresponding to the non-vibratable parts 14 of the circuit board 11, elastomer layer 12 and bottom support board 13 of the trigger module 1 to set settings, to open a menu, to start a function, to typewrite or to chat on the web, the vibrator 15 does no work. Further, when going to perform word processing, to connect to the internet or to key in data, the user can switch off the vibration function. Thus, the invention greatly enhances keyboard efficacy without affecting user's habits in using a keyboard.

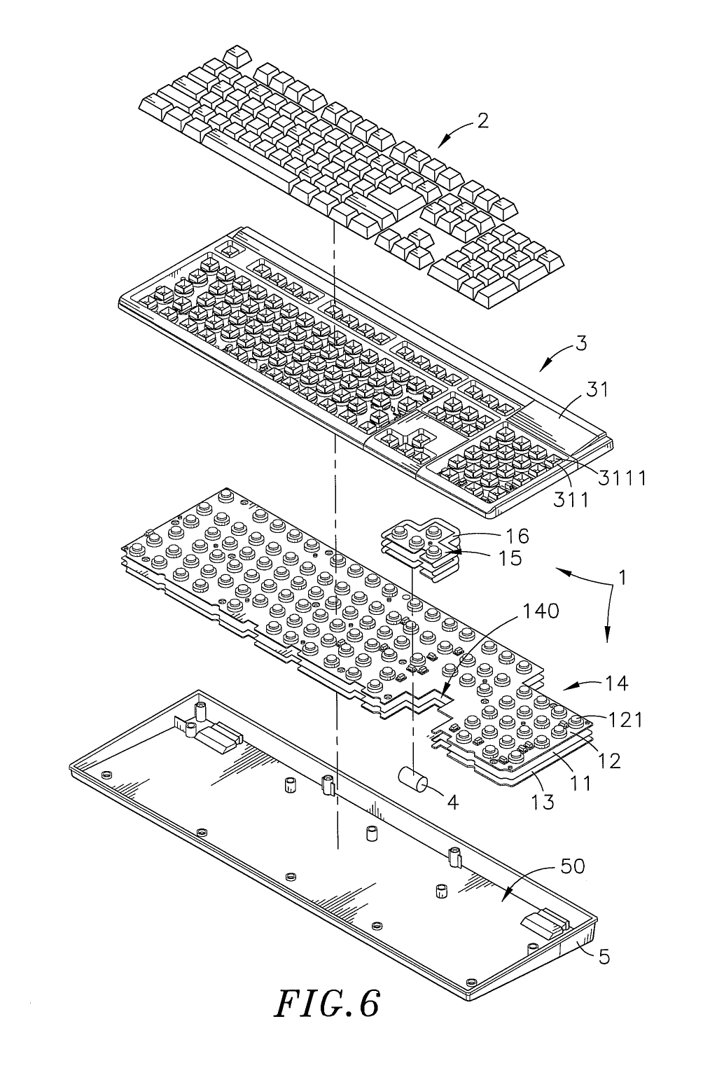

FIG. 6 illustrates a body sensing computer keyboard in accordance with a third embodiment of the present invention. This third embodiment is substantially similar to the aforesaid second embodiment with the exception that buffer cushions 16 are connected between the non-vibratable parts 14 of the circuit board 11, elastomer layer 12 and bottom support board 13 of the trigger module 1 and the respective vibratable parts 15. The buffer cushions 16 can be selected from the material group of rubber, silicon rubber, latex and sponge. The buffer cushions 16 not only connect the vibratable parts 15 of the circuit board 11, elastomer layer 12 and bottom support board 13 of the trigger module 1 and the respective non-vibratable parts 14 to avoid the necessity of modifying the mounting structures of the holder shell 31 and the base member 5 but also can absorb vibrating waves during operation of the vibrator 4 to vibrate the vibratable parts 15 of the circuit board 11, elastomer layer 12 and bottom support board 13 of the trigger module 1. Thus, the non-vibratable parts 14 of the circuit board 11, elastomer layer 12 and bottom support board 13 of the trigger module 1 are free from the effects of vibration of the vibratable parts 15. Therefore, this design achieves the effects of cost saving, accurate positioning and local vibration.

Further, the trigger module 1 has flexible flat cables or flexible flat cables with connectors arranged thereon to provide electrical connection between the non-vibratable part 14 and vibratable part 15 of the circuit board 11 for allowing transmission of signals to the computer. However, other measures to achieve electrical connection between the non-vibratable part 14 and vibratable part 15 of the circuit board 11 may be selectively employed without departing from the spirit and scope of the invention.

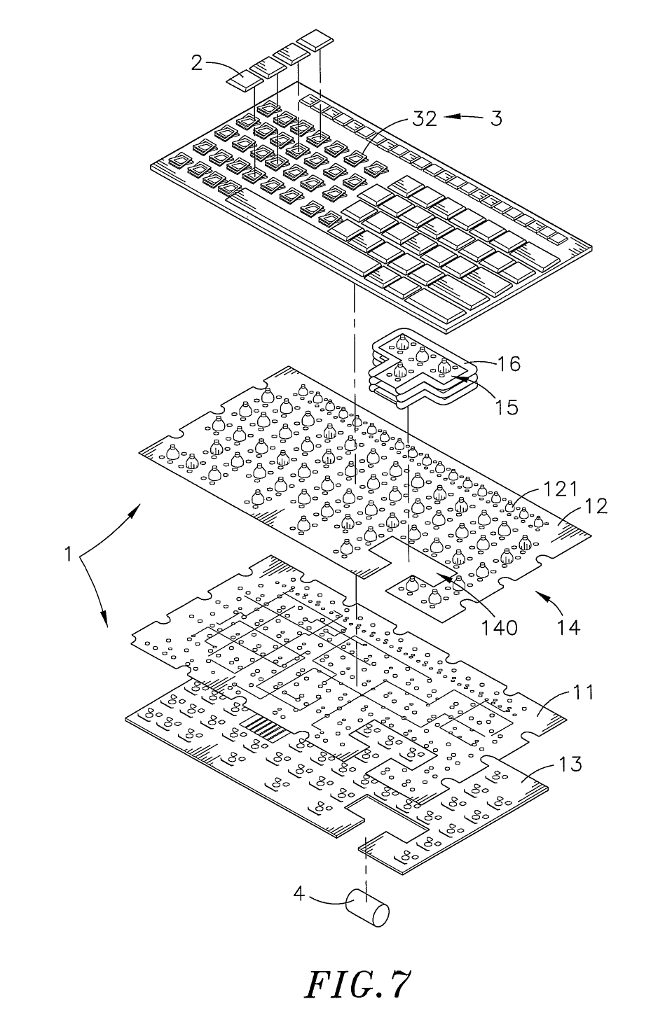

FIG. 7 illustrates a body sensing computer keyboard in accordance with a fourth embodiment of the present invention. Unlike the first through third embodiments described above for desk computer, this fourth embodiment is adapted for use in a notebook computer. Further, the displacement unit 3 in this fourth embodiment comprises a plurality of cross linkages 32 respectively coupled between the bottom support board 13 of the trigger module 1 and the key buttons 2, allowing the key buttons 2 to be moved up and down relative to the bottom support board 13 of the trigger module 1.

In actual application, the body sensing computer keyboard has the following features and advantages:
1. The vibrator 4 is provided at the bottom side of the bottom support board 13 of the trigger module 1 and can be driven by the vibration driving circuit 101 to vibrate the trigger module 1 and one or a number of key buttons 2 subject to the control of the microprocessor 10 upon triggering of the circuit board 11 by one key button 2, and thus, the user can release the finger from each pressed key button 2 immediately upon vibration of the vibrator 4 without moving the key button 2 to the lower limit position, shortening the stroke of the key button 2.
2. In another embodiment of the present invention, the circuit board 11, elastomer layer 12 and bottom support board 13 of the trigger module 1 each defines a non-vibratable part 14 and a vibratable part 15 that is accommodated in an opening 140 in the non-vibratable part 14. Thus, only a local part of the body sensing computer keyboard will be vibrated during vibration of the vibrator 4, enabling the user to feel a true shock during the playing of a computer game. When performing word processing, connecting the body sensing computer keyboard to the internet, or operating the body sensing computer keyboard to key in data, the non-vibratable parts 14 of the circuit board 11, elastomer layer 12 and bottom support board 13 of the trigger module 1 are free from the effects of vibration of the vibratable parts 15.
3. In still another embodiment of the present invention, buffer cushions 16 are connected between the non-vibratable parts 14 of the circuit board 11, elastomer layer 12 and bottom support board 13 of the trigger module 1 and the respective vibratable parts 15. The buffer cushions 16 not only connect the vibratable parts 15 of the circuit board 11, elastomer layer 12 and bottom support board 13 of the trigger module 1 and the respective non-vibratable parts 14 to avoid the necessity of modifying the mounting structures of the holder shell 31 and the base member 5 but also can absorb vibrating waves during operation of the vibrator 4 to vibrate the vibratable parts 15 of the circuit board 11, elastomer layer 12 and bottom support board 13 of the trigger module 1.

In conclusion, the invention provides a body sensing computer keyboard, which comprises a trigger module 1, which comprises a circuit board 11 carrying a microprocessor 10 and a vibration driving circuit 101, an elastomer layer 12 disposed at the top side of the circuit board 11 and a bottom support board 13 attached to the bottom side of the circuit board 11 to give support, a plurality of key buttons 2 arranged at the top side of the trigger module 1, a displacement unit 3 set between the trigger module 1 and the key buttons 2, a vibrator 4 provided at the bottom side of the bottom support board 13 of the trigger module 1 and electrically connected to the vibration driving circuit 101, and a base member 5 provided at the bottom side of the bottom support board 13 of the trigger module 1 and the vibrator 4 and assembled with the holder shell 31 of the displacement unit 3. When one key button 2 is clicked to trigger the circuit board 13 in generating a respective signal, the vibration driving circuit 101 drives the vibrator 4 to vibrate the trigger module 1 subject to the control of the microprocessor 10. Thus, with the vibration of the vibrator 4, the user can feel accurate triggering when clicking one key button 2.

A prototype of body sensing computer keyboard has been constructed with the features of FIGS. 1˜7. The body sensing computer keyboard works smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A body sensing computer keyboard, comprising:
a trigger module comprising a circuit board carrying a microprocessor and a vibration driving circuit, an elastomer layer disposed at a top side of said circuit board, and a bottom support board attached to a bottom side of said circuit board, said circuit board, said elastomer layer and said bottom support board each defining a non-vibratable part and a vibratable part, the non-vibratable parts of said circuit board, said elastomer layer and said bottom support board providing a respective opening to accommodate the vibratable parts of said circuit board, said elastomer layer and said bottom support board;
a plurality of key buttons respectively mounted at a top side of said trigger module and respectively clickable to trigger said circuit board in generating a respective signal;
a displacement unit set between said trigger module and said key buttons, said displacement unit comprising a holder shell for supporting said key buttons; and
a vibrator provided at a bottom side of the vibratable part of said bottom support board and electrically connected to said vibration driving circuit.

2. The body sensing computer keyboard as claimed in claim 1, wherein each said key button comprises a downwardly extending plunger insertable through said holder shell.

3. The body sensing computer keyboard as claimed in claim 1, wherein said elastomer layer comprises a plurality of rubber cones respectively elastically compressible by said key buttons to trigger said circuit board in generating a respective signal.

4. The body sensing computer keyboard as claimed in claim 1, further comprising a base member provided at a bottom side relative to said bottom support board of said trigger module and said vibrator and assembled with said holder shell of said displacement unit, said base member defining with said holder shell an accommodation chamber that accommodates said trigger module and said vibrator.

5. The body sensing computer keyboard as claimed in claim 1, wherein said trigger module further comprises a plurality of buffer cushions connected between the non-vibratable parts of said circuit board, said elastomer layer and said bottom support board and the respective vibratable parts.

6. The body sensing computer keyboard as claimed in claim 1, wherein said displacement unit further comprises a plurality of raised guide blocks formed integral with said holder shell and arranged at locations corresponding to said key buttons, and a vertical sliding way cut through opposing top and bottom sides of each said raised guide block for guiding vertical movement of said key buttons.

7. The body sensing computer keyboard as claimed in claim 1, wherein said displacement unit comprises a plurality of cross linkages arranged in said holder shell and respectively coupled between said bottom support board of said trigger module and said key buttons for guiding said key buttons to move up and down.
